(19) United States
(12) Patent Application Publication
(10) Pub. No.: US 2022/0292307 A1
(43) Pub. Date: Sep. 15, 2022

(54) COMPUTER-IMPLEMENTED METHOD AND DEVICE FOR TRAINING A DATA-BASED POINT IN TIME DETERMINATION MODEL FOR DETERMINING AN OPENING POINT IN TIME OR A CLOSING POINT IN TIME OF AN INJECTION VALVE WITH THE AID OF MACHINE LEARNING METHODS

(71) Applicant: Robert Bosch GmbH, Stuttgart (DE)

(72) Inventor: Konrad Groh, Stuttgart (DE)

(21) Appl. No.: 17/685,891

(22) Filed: Mar. 3, 2022

(30) Foreign Application Priority Data
Mar. 9, 2021 (DE) 10 2021 202 289.8

(51) Int. Cl. G06K 9/62; G01M 15/04

(52) U.S. Cl. CPC G06K 9/6256; G06K 9/6276; G01M 15/04

(57) ABSTRACT

A computer-implemented method for training a data-based point in time determination model for ascertaining an opening or closing point in time of an injection valve of an internal combustion engine, based on a sensor signal. The method includes:
providing a set of training data sets from a measurement of the internal combustion engine by scanning the sensor signal of a sensor of the injection valve on a test stand, the training data sets assigning a time indication of the opening or closing point in time to an evaluation point time series; assigning a difficulty value to each training data set; classifying the training data sets into a number of difficulty classes corresponding to their respective difficulty value; ascertaining new training data sets as a function of the training data sets assigned to each difficulty class; training the model with the set of new training data sets.

### FIELD

The present invention relates to methods for providing training data for training a data-based point in time determination model for determining an opening point in time or a closing point in time of an injection valve and, in particular, to measures for improving the training data for training the point in time determination model.

### BACKGROUND INFORMATION

Data-based models such as, for example, neural networks, are able to model diverse, complex correlations. However, the use of data-based models in safety-critical applications is limited, since it is generally not possible to completely reconstruct the reliability of the model output. For the training of a data-based model, training data are generally ascertained by measurements at a technical system or in another manner and these measurements are used by suitable learning methods such as, for example, backpropagation, for training the data-based model.

Electromechanical or piezoelectric injection valves are used for metering fuel in internal combustion engines. These enable a direct and exactly measured fuel feed into the cylinders of the internal combustion engine.

One challenge is to control the combustion process as exactly as possible in order to improve operating characteristics of the internal combustion engine, in particular, with respect to fuel consumption, efficiency, pollutant emissions and engine smoothness. For this purpose, it is essential to operate the injection valves in such a way that the amount of fuel to be injected may be metered with high repetition accuracy, at varying working pressures and, if necessary, with multiple injections per power stroke.

Injection valves may include an electromagnetic actuator or piezo actuator, which actuate a valve needle in order to lift the valve needle from a needle seat and to open an outlet opening of the injection valve for discharging the fuel into the internal combustion chamber. Due to structural differences and different operating conditions, such as temperature, fuel pressure, fuel viscosity, there is an uncertainty when determining the exact opening point in time, i.e., the point in time from which the fuel passes through the injection valve into the combustion chamber of the cylinder, and of the exact closing point in time of the injection valve, i.e., the point in time up to which fuel passes through the injection valve into the combustion chamber of the cylinder.

The determination of an opening point in time and of a closing point in time of an injection valve may be carried out with the aid of a trained data-based point in time determination model. The model is trained based on training data, which are able to specify, for example, to a times series of a sensor signal in each case an indication of the opening point in time or closing point in time of the injection valve.

### SUMMARY

According to the present invention, a method for training a data-based point in time determination model for ascertaining an opening point in time or a closing point in time of an injection valve, as well as a device, are provided.

Example embodiments of the present invention are disclosed herein.

According to one first aspect of the present invention, a computer-implemented method for training a data-based point in time determination model is provided for ascertaining an opening point in time or a closing point in time of an injection valve of an internal combustion engine, including the following steps:
providing a set of training data sets, in particular, from a measurement of the internal combustion engine by scanning the sensor signal of a sensor of the injection valve on a test stand, the training data sets assigning a time indication of the opening point in time or of the closing point in time as an output vector to an evaluation point time series as an input vector;
assigning a difficulty value to each training data set, the difficulty values each specifying a consistency of the time indications for the relevant training data set;
classifying the training data sets into a number of difficulty classes corresponding to their respective difficulty value;
ascertaining new training data sets as a function of the training data sets assigned to each difficulty class;
training the data-based point in time determination model with the set of new training data sets.

Although the activation of an injection valve takes place according to a predefined profile of an activation signal, the opening movements and closing movements caused as a result vary, so that the actual opening points in time and closing points in time at the start and the end of the fuel injection are not able to be exactly predefined. The cause of this lies in the complex dependencies of the valve movement on the instantaneous operating point.

In accordance with an example embodiment of the present invention, in order to monitor the valve movement, a piezo sensor is provided in the injection valves, which is designed as a pressure sensor, in order to detect the pressure changes of a fuel pressure triggered by the activation of the injection valve and to provide a corresponding sensor signal. The measured sensor signal may now be evaluated for ascertaining the actual opening points in time and closing points in time, in order in this way to adapt the activation of the injection valve accordingly.

The evaluation point time series is obtained by scanning the sensor signal according to a predefined scanning rate, the evaluation point time series being determined for a predefined evaluation time period. The remaining scanning values are not part of the evaluation point time series.

However, the sensor signal is also noisy and is a function, in particular, of the actual fuel pressure in the fuel feed and of the duration of the activation to be measured.

In accordance with an example embodiment of the present invention, the evaluation of the sensor signal for ascertaining an opening point in time or closing point in time of the injection valve may be carried out with the aid of a data-based point in time determination model. The data-based point in time determination model may correspond to a neural network, to a probabilistic regression model or to some other data-based model.

The sensor signal of the piezo sensor corresponds to a voltage signal and may indicate an opening point in time and closing point in time of the injection valve.

To train the point in time determination model, evaluation point time series may be predefined, each of which are provided with a label in order to form training data sets. One label corresponds to a specification of an assigned opening point in time or closing point in time of an injection valve. The training data thus created are obtained via the measurement of the internal combustion engine on a test stand, the different opening time durations being predefined for different activation signals of the injection valve, evaluation point time series being recorded and the corresponding actual opening point in time or closing point in time being determined by a suitable test stand sensor system.

The training data may assign one time indication each to the time series of the sensor signal. The time indication may be coded in various ways, the time indication may, in particular, be ascertained by a classification, different classes being assigned to the different opening points in time or closing points in time. In accordance with the scan rate of the time series of the sensor signal, one output class may be assigned to each of the points in time, each of which corresponds to an assigned point in time. Using the number of classes, it is possible to establish the temporal resolution in the determination of the time indication. Alternatively, the time indication may also be indicated in the form of a floating point value.

According to an example embodiment of the present invention, the training data may be manipulated prior to the training of the point in time determination model, so that a more exact training of the point in time determination model may be carried out, in particular, in difficult areas, in which at least partially contradictory training data are present. This makes it possible to be able to enhance the reliability, in particular in those areas in which no sufficient training data are present, in particular, by providing the training data equally distributed over the entire training data space.

To determine the difficulty value for each training data set considered, a predetermined number of closest neighbors may further be ascertained as neighboring training data sets with respect to the evaluation point time series, the difficulty value being assigned to the respective considered training data set as a function of the time indications of the neighboring training data sets.

The data-based point in time determination model may, in particular, be designed as a classification model, a number of output classes being defined, each of which is assigned to an opening point in time or to a closing point in time, so that the training data sets assign one evaluation point time series each to one of the output classes, the difficulty value of each of the training data sets corresponding to or being a function of the number of the different class assignments of the neighboring training data sets.

In this case, the number of difficulty classes may correspond to the number of the output classes.

Alternatively, the data-based point in time determination model may be designed as a regression model, the training data sets each assigning one evaluation point time series to one opening point in time or to one closing point in time, the difficulty value of each of the training data sets corresponding to or being a function of a variance of the opening points in time or closing points in time of the neighboring training data sets.

It may be provided that the ascertainment of new training data sets is carried out for each of the difficulty classes by ascertaining a predefined number of training data sets for each of the difficulty classes.

The predefined number for each of the difficulty classes may, in particular, be identical or may differ from one another by not more than 10%.

According to one specific embodiment of the present invention, training data sets may be ascertained for each of the difficulty classes by selecting from the training data sets assigned to the respective difficulty class or by generating training data sets as a function of the training data sets assigned to the difficulty class. The generation of these training data sets may be carried out using a data augmentation method such as, for example, bucket sampling or by applying a noise model to training data points assigned to the relevant difficulty class, for example, by adding each element of the input vector of the training data set to a parameterizable noise variable.

According to one further aspect of the present invention, a method may be provided for operating an injection valve by ascertaining an opening point in time or a closing point in time of the injection valve based on a sensor signal and on a data-based point in time determination model, which has been trained according to the above method, the operation of the injection valve being carried out as a function of the opening point in time and/or or of closing point in time, the operation of the injection valve being carried out, in particular, in such a way that an opening duration of the injection valve, which is determined by the ascertained opening point in time and/or closing point in time, is set to a predefined setpoint opening duration.

According to one further aspect of the present invention, a device is provided for carrying out one of the above methods.

### BRIEF DESCRIPTION OF THE DRAWINGS

Specific embodiments of the present invention are explained in greater detail below with reference to the figures.

FIG. 1 schematically shows a representation of an injection system for the injection of fuel into the cylinder of an internal combustion engine.

FIG. 2 shows a flowchart for representing a method for training a data-based point in time determination model for determining an opening point in time or a closing point in time of an injection valve, in accordance with an example embodiment of the present invention.

FIG. 3 shows an exemplary representation of an evaluation point time series.

### DETAILED DESCRIPTION OF EXAMPLE EMBODIMENTS

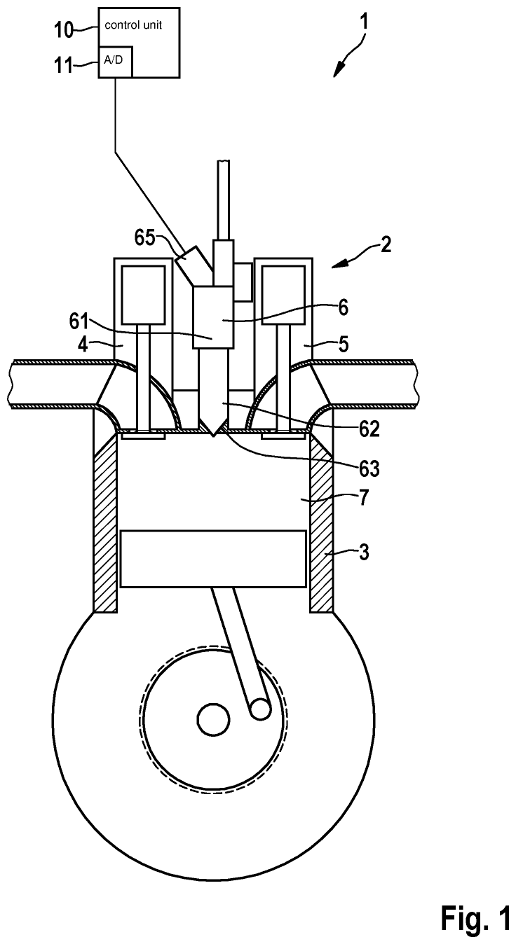

FIG. 1 shows an arrangement of an injection system 1 for an internal combustion engine 2 of a motor vehicle, for which one cylinder 3 (of, in particular, multiple cylinders) is shown by way of example. Internal combustion engine 2 is designed preferably as a diesel engine with direct injection, but may also be provided as a gasoline engine.

Cylinder 3 includes an inlet valve 4 and an outlet valve 5 for feeding fresh air and for discharging combustion exhaust gas.

Furthermore, fuel is injected into a combustion chamber 7 of cylinder 3 via an injection valve 6 for operating internal combustion engine 2. For this purpose, fuel is fed to the injection valve via a fuel feed 8, via which the fuel is provided under a high fuel pressure in a conventional manner (for example, common rail).

Injection valve 6 includes an electromagnetically or piezoelectrically activatable actuator unit 61, which is coupled to a valve needle 62. Valve needle 62 is seated in the closed state of injection valve 6 on a needle seat 63. By activating actuator unit 61, valve needle 62 is moved in the longitudinal direction and unblocks a portion of a valve opening in needle seat 63, in order to inject the pressurized fuel into combustion chamber 7 of cylinder 3.

Injection valve 6 further includes a piezo sensor 65, which is situated in injection valve 6. Piezo sensor 65 is deformed by pressure changes in the fuel guided through injection valve 6 and is generated by a voltage signal as a sensor signal.

The injection takes place controlled by a control unit 10, which predefines a quantity of fuel to be injected by energizing actuator unit 61. The sensor signal is temporally scanned in control unit 10 with the aid of an A/D converter 11, in particular, at a scan rate of 0.5 MHz to 5 MHz.

The sensor signal is used in the operation of internal combustion engine 2 for ascertaining a correct opening point in time and/or closing point in time of injection valve 6. For this purpose, the sensor signal is digitized into a sensor signal time series with the aid of A/D converter 11 and evaluated by a suitable point in time determination model, from which an opening time duration of injection valve 6 and accordingly an injected quantity of fuel may be ascertained as a function of the fuel pressure and of further operating variables. To determine the opening time duration, an opening point in time and a closing point in time, in particular, are required, in order to ascertain the opening time duration as the temporal difference of these variables.

The ascertainment of an opening point in time and/or of a closing point in time may be carried out based on the consideration of the sensor signal profile. The opening point in time or the closing point in time may, in particular, be determined with the aid of a data-based point in time determination model. Measured training data sets are used for training the data-based point in time determination model.

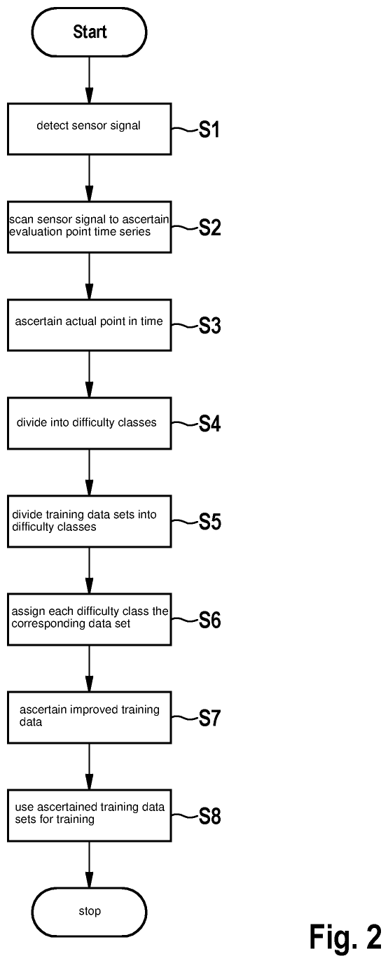

FIG. 2 illustrates with reference to a flowchart a method for training such a data-based point in time determination method, which may be used during operation in an above-described engine system 1 for ascertaining an opening point in time or a closing point in time of an injection valve 6 of a cylinder 3. The method may be carried out in a control system of a test stand. The test stand makes it possible to measure injection valves 6 in an engine system 1, so that a corresponding opening point in time and/or closing point in time may be exactly detected with the aid of an additional sensor system as a function of an activation signal for actuator unit 61. The sensor signal of piezo sensor 65 is scanned for this purpose and a correspondingly scanned evaluation point time series of a resulting voltage signal at a resolution of, for example, between 5 μs and 20 μs is detected.

In step S1, a sensor signal is detected with the aid of piezo sensor 65. This signal is generally a voltage signal, which is generated due to pressure changes in the fed fuel.

In step S2, the sensor signal is scanned with the aid of A/D converter 11, in order to ascertain an evaluation point time series within one evaluation time period. The evaluation time period may be established with respect to an activation time window of the injection valve. The activation time window is defined by the start of the activation of actuator unit 61 and an established time period, which corresponds to a maximum time period, in which the activation signal for actuator unit 61 predefines a valve opening. Thus, the activation time window includes a defined time reference, for which an evaluation point time series is provided, which represents the basis for the further ascertainment of an opening point in time or closing point in time. The evaluation point time series may, in particular, be ascertained by downsampling the sensor signal previously overscanned.

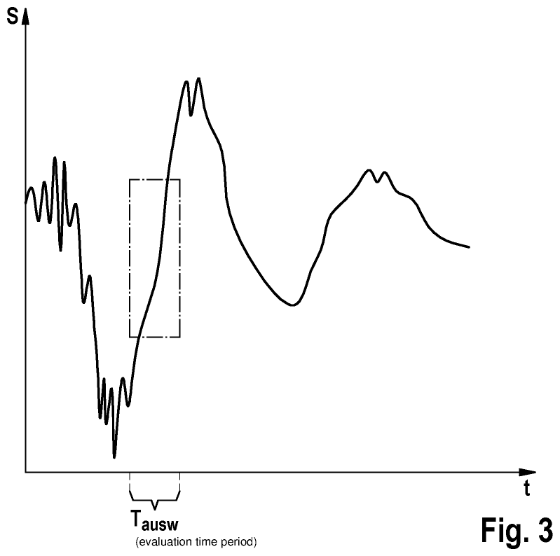

The evaluation time period may be provided with a fixed time reference to the power strokes of internal combustion engine 2, in particular, the evaluation time period in a predefined crankshaft position may preferably start within the compression stroke. The evaluation time period may thus be selected so that the entire opening time window of injection valve 6 may be reflected therein. Such an evaluation time period T_{ausw} with an exemplary evaluation point time series of sensor signal S over time t is shown in FIG. 3.

In step S3, an actual point in time is ascertained in accordance with a test stand sensor system on a test stand as an opening point in time or a closing point in time for an evaluation point time series. This time indication is adopted as a label for the previously determined associated evaluation point time series, so that a training data set is formed.

The training data set may assign the time indication of the opening point in time or closing point in time directly to the evaluation point time series.

Alternatively, the point in time determination model may also be trained as a classification model, the output of the classification model predefining one point in time each as a possible opening point in time or closing point in time corresponding to a desired temporal resolution. The output classes of such a classification model are assigned to one possible point in time each.

The model output may thus be an output vector in the form of a log it. The output vector in this case is defined in such a way that the index of the elements of the output vector indicates a corresponding opening point in time or closing point in time. For example, given a number of n evaluation points, the output vector may correspondingly include a number of n elements. The indices of the elements of the output vectors in this case are assigned to consecutive points in time within a considered evaluation time period. The points in time assigned to the elements of the output vector may, in particular, correspond to the temporally equidistant evaluation points in time.

Thus, for example, a value of an output class of “1” may indicate that the point in time corresponds to a point in time that is assigned to this output class. Similarly, a value of an output class of “0” may indicate that the opening point in time or closing point in time does not correspond to a point in time that is assigned to this output class. Such a classification model outputs for each output class a value, which indicates a probability with which the point in time that is assigned to the corresponding output class is the opening point in time or closing point in time to be ascertained.

In the following, a classification model as a point in time determination model is assumed. The point in time determination model designed as a classification model may now be trained using training data sets, which assign to one evaluation point time series each the class assignment that corresponds to the opening point in time or to the closing point in time of injection valve 6.

For this purpose, the training data sets are initially divided into difficulty classes in step S4. The difficulty classes indicate how suitable the corresponding training data sets are for the training of the data-based point in time determination model. For categorizing in the difficulty class, each evaluation point time series of each training data set is initially analyzed, in order to determine the K closest neighbor within all training data sets. The number K of the neighbors to be determined may be predefined and should lie preferably between 5 and 50. The determination of the neighbor may take place, for example, by comparing the Euclidean distances to one another. Thus, a group of further training data sets, which are assumed to be the closest neighbors, is determined for the evaluation point time series of each training data set.

The training data sets (neighboring training data sets) assigned as neighbors, which are assigned to the respectively considered training data set, are assigned one label (output class) each, which are compared with one another. If the label corresponds to a point in time, then the variance of the points in time relative to one another may be established as a difficulty value. If the point in time determination model is a classification model, then the difficulty value may correspond to the number of the different output classes of the neighboring training data sets or may be determined as a function of the former.

In this way, it is possible to assign a difficulty value to each considered training data set.

In a subsequent step S5, the training data sets are divided into difficulty classes, into which the range of the difficulty values is subdivided. The number of difficulty classes may maximally correspond to the number of considered neighboring training data sets.

In step S6, each of the difficulty classes is assigned the corresponding training data set, into which the corresponding difficulty value falls.

In a subsequent step S7, improved training data are ascertained from the classified training data sets as a function of the assignments to the difficulty classes. In this case, the new training data may be generated from the difficulty classes, an identical or a differing number of training data sets being ascertained for each difficulty class. The number of the training data sets for each difficulty class may also be selected as a function of the number of the training data sets for the relevant difficulty class. The numbers should preferably be selected in such a way that for the difficulty class that includes the fewest training data sets, a number of training data sets is generated, which corresponds to a tenth of the elements of the difficulty class that includes the largest number of training data sets.

The new training data sets may, in particular, be selected from the training data sets assigned to the difficulty classes.

Alternatively, the training data sets may also be selected from the difficulty classes by bucket sampling. The bucket sampling is intended for generating new training elements using bucket sampling from the underlying time series of the training data set, whose signal with a lower rate of, for example, 8 μs is generated by rastering from a signal with a higher rate of, for example, 1 μs. For this purpose, instead of scanning the underlying signal of the lower rate, a bucket of a fixed size, which is centered in the grid of the lower rate, is defined. In the case of bucket sampling, instead of selecting the midpoint from the time window defined by the grid, an element of the bucket is now randomly selected. For a bucket of the size 8, one of eight values may then be selected for each value of the time series. Thus, the bucket sampling generates new training data, which conform to the profile of the underlying signal profile, the associated label remaining the same.

In step S8, the training data sets thus ascertained are subsequently used for the training of the point in time determination model in a conventional manner, for example, utilizing conventional training methods such as, for example, with the aid of backpropagation or the like.

1-12. (canceled)

13. A computer-implemented method for training a data-based point in time determination model for ascertaining an opening point in time or closing point in time of an injection valve of an internal combustion engine, based on a sensor signal, the method comprising the following steps:
providing a set of training data sets from a measurement of the internal combustion engine by scanning the sensor signal of a sensor of the injection valve on a test stand, the training data sets assigning a time indication of the opening point in time or of the closing point in time to an evaluation point time series;
assigning a respective difficulty value to each training data set of the training data sets, the difficulty values each specifying a consistency of the time indications for the training data set;
classifying the training data sets into a number of difficulty classes corresponding to their respective difficulty value;
ascertaining new training data sets as a function of the training data sets assigned to each of the difficulty classes; and
training the data-based point in time determination model with a set of the new training data sets.

14. The method as recited in claim 13, wherein for determining the respective difficulty value for each training data set, a predetermined number of closest neighbors is ascertained as neighboring training data sets with respect to the evaluation point time series of the training data sets, the training data set being assigned the respective difficulty value as a function of time indications of the neighboring training data sets.

15. The method as recited in claim 14, wherein the data-based point in time determination model is a classification model, a number of output classes being defined, which are assigned to one opening point in time or to one closing point in time each, so that the training data sets assign one evaluation point time series each to one of the output classes, the difficulty value of each of the training data sets corresponding to or being a function of a number of the different class assignments of the neighboring training data sets.

16. The method as recited in claim 15, wherein a number of difficulty classes corresponds to the number of the output classes.

17. The method as recited in claim 14, wherein the data-based point in time determination model is a regression model, the training data sets assigning one evaluation point time series each to an opening point in time or to a closing point in time, the difficulty value of each of the training data sets corresponding to or being a function of a variance of the opening points in time or of the closing points in time of the neighboring training data sets.

18. The method as recited in claim 13, wherein the ascertainment of the new training data sets is carried out for each of the difficulty classes by ascertaining a predefined number of training data sets for each of the difficulty classes.

19. The method as recited in claim 18, wherein the predefined number for each of the difficulty classes is identical or differs from one another by not more than 10%.

20. The method as recited in claim 18, wherein the predefined number of training data sets are ascertained for each of the difficulty classes by selecting from the training data sets assigned to the difficulty class or by generating training data sets as a function of the training data sets assigned to the difficulty class using a data augmentation method by bucket sampling or by applying a noise model.

21. A method for operating an injection valve, comprising:
ascertaining an opening point in time or closing point in time of the injection valve, based on a sensor signal and on a data-based point in time determination model, which has been trained by:
providing a set of training data sets from a measurement of the internal combustion engine by scanning the sensor signal of a sensor of the injection valve on a test stand, the training data sets assigning a time indication of the opening point in time or of the closing point in time to an evaluation point time series,
assigning a respective difficulty value to each training data set of the training data sets, the difficulty values each specifying a consistency of the time indications for the training data set,
classifying the training data sets into a number of difficulty classes corresponding to their respective difficulty value,
ascertaining new training data sets as a function of the training data sets assigned to each of the difficulty classes, and
training the data-based point in time determination model with a set of new training data sets;
operating the injection valve as a function of the opening point in time and/or of the closing point in time, the operation of the injection valve being carried out in such a way that an opening duration of the injection valve, which is determined by the ascertained opening point in time and/or closing point in time, is set to a predefined setpoint opening duration.

22. A device configured to train a data-based point in time determination model for ascertaining an opening point in time or closing point in time of an injection valve of an internal combustion engine, based on a sensor signal, the device configured to:
provide a set of training data sets from a measurement of the internal combustion engine by scanning the sensor signal of a sensor of the injection valve on a test stand, the training data sets assigning a time indication of the opening point in time or of the closing point in time to an evaluation point time series;
assign a respective difficulty value to each training data set of the training data sets, the difficulty values each specifying a consistency of the time indications for the training data set;
classify the training data sets into a number of difficulty classes corresponding to their respective difficulty value;
ascertain new training data sets as a function of the training data sets assigned to each of the difficulty classes; and
train the data-based point in time determination model with a set of the new training data sets.

23. A non-transitory machine-readable memory medium on which are stored commands for training a data-based point in time determination model for ascertaining an opening point in time or closing point in time of an injection valve of an internal combustion engine, based on a sensor signal, the commands, when executed by a computer, causing the computer to perform the following steps:
providing a set of training data sets from a measurement of the internal combustion engine by scanning the sensor signal of a sensor of the injection valve on a test stand, the training data sets assigning a time indication of the opening point in time or of the closing point in time to an evaluation point time series;
assigning a respective difficulty value to each training data set of the training data sets, the difficulty values each specifying a consistency of the time indications for the training data set;
classifying the training data sets into a number of difficulty classes corresponding to their respective difficulty value;
ascertaining new training data sets as a function of the training data sets assigned to each of the difficulty classes; and
training the data-based point in time determination model with a set of the new training data sets.
